(19) United States
(12) Patent Application Publication
(10) Pub. No.: US 2003/0074173 A1
(43) Pub. Date: Apr. 17, 2003

(54) Technique for defining probabilistic reliability test requirements

(75) Inventor: Eric M. Monroe, Chandler, AZ (US)

Correspondence Address: KENYON & KENYON, 333 W. San Carlos Street, Suite 600, San Jose, CA, 95110-2711, US

(73) Assignee: Intel Corporation

(21) Appl. No.: 09/982,061

(22) Filed: Oct. 17, 2001

(51) Int. Cl. G06F 17/50

(52) U.S. Cl. 703/13

(57) ABSTRACT

A method for relating expected frequencies and magnitudes of temperature fluctuations encountered by the package/chip device over a product lifetime to parameters of an accelerated life test used to assess reliability is provided. A particular market application use for the package/chip device is specified, and expected frequencies and magnitudes of temperature fluctuations of the package/chip device in each of a plurality of temperature fluctuation regimes are quantified. The expected frequencies and magnitudes of fluctuations in each of the regimes are dependent on the particular market application use of the package/chip device. The quantified expected frequencies and magnitudes of the temperature fluctuations of the package/chip device in each of the temperature regimes are incorporated into an accelerated life model in which parameters of the accelerated life test are related to the frequencies and magnitudes of the temperature fluctuations in each of the temperature fluctuation regimes.

### FIELD OF THE INVENTION

The present invention relates to the field of electronic equipment reliability testing. More specifically, it relates to a method for systematically translating field temperature conditions associated with particular packages/products into accelerated life testing requirements based on a pre-determined set of design use inputs, consumer behavior patterns, and environmental field conditions.

### BACKGROUND INFORMATION

Central Processing Unit (CPU) and certain non-CPU electronic chips are generally embedded in a package unit that provides several design advantages. Package units facilitate attachment to a computer motherboard and enhance thermal dissipation from the chip. The package units also provide a convenient structural interface for transmitting power to the chip and routing input/output (I/O) signals. Over time, temperature fluctuations, caused by typical events that occur either in the external environment of the relevant product or internally within the chip, can cause the package units to fail. One common cause of such failures is solder-ball fatigue, in which the solder balls that connect package units to the motherboard collapse due to cyclical stress fatigue driven from temperature fluctuations. These temperature fluctuations can also stress interfaces between the chip and the packaging unit as a result of differing thermal expansion coefficients for materials across the interfaces. The stresses may reach a level where the package or chip fails due to fretting, warping, bowing or cracking. Such failures that occur over the operational lifetime of the relevant product are a problem for silicon chip manufacturers that generally guarantee the operability of the chip/package unit over a warranty lifetime, typically seven to ten years.

Therefore, to ensure the reliability of chip and package products, tests are conducted under conditions that simulate the effects of the temperature fluctuations that are likely to occur over the warranty lifetime of the products. Since it is impractical to perform simulations over long periods of time, i.e., over the actual length of the warranty period, reliability tests are conducted under accelerated conditions. Acceleration may occur by exposing the package unit to temperature conditions that are more extreme than normal field conditions (such as in Temperature Cycling) or may result from maintaining typical temperature fluctuations and compressing the time scale for how frequently events occur (such as in Power Cycling).

However, accelerated reliability test requirements cannot be accurately defined without a well-defined set of environmental use conditions pertaining to a specific product and an algorithm to quantify the expected frequency and magnitude of temperature fluctuations across the chip and the package unit. To compensate for this uncertainty and lack of accuracy, accelerated reliability test requirements are generally over-estimated (guard banded). In other cases, requirements are related to a baseline such as a military standard, which has been prescribed for unrelated products. Thus, by failing to consider the appropriate environmental conditions and application use factors, designs may be forced to meet requirements that are not necessary for their use conditions (e.g. extreme cold from outer space).

### BRIEF DESCRIPTION OF THE DRAWINGS

FIG. 1 is a functional block diagram depicting the algorithms used to systematically translate the field operating temperature conditions associated with a package/chip to the accelerated life testing conditions according to the present invention.

FIG. 2 illustrates a representative program interface used for inputting user-defined criterion according to the present invention.

FIG. 3 illustrates schematic graphs of an exemplary power and temperature fluctuation profile for a package/chip device over time.

FIG. 4 shows a modified Coffin-Manson empirical model, which calculates the number of accelerated test cycles required to account for temperature fluctuations in each of the temperature fluctuation regimes.

FIG. 5 displays exemplary input and output data from a calculated temperature profile and accelerated life model for a mobile (laptop) computer that incorporates a package/chip device.

FIG. 6 illustrates the effect package location has on mean temperature and temperature fluctuations within electronic devices subject to power cycle fluctuations.

### DETAILED DESCRIPTION

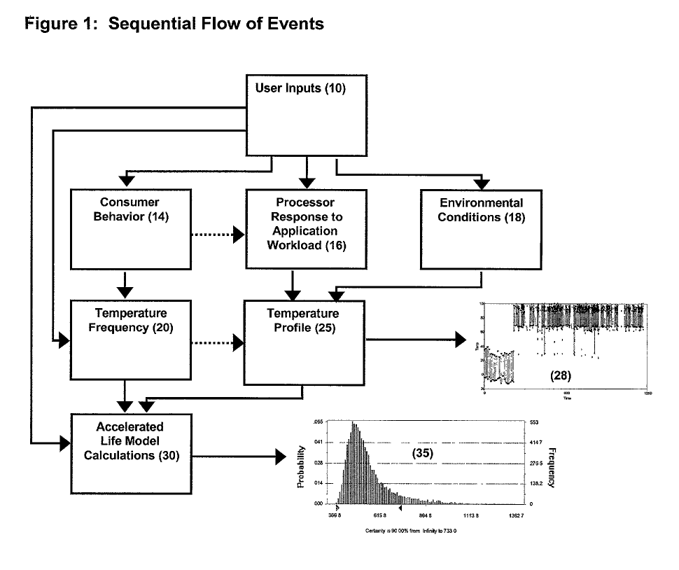

In accordance with the present invention, a statistically rigorous method ties consumer behavior, package/chip use environment, environmental weather information, material property behavior, and accelerated life-testing models together. A functional block diagram of the present invention is shown in FIG. 1, which indicates various inputs and/or subroutines, which may be executed on a general-purpose computer or electronic device having attached memory. User-defined criterion (“user inputs”) related to package unit design and use, such as the product use market, the accelerated test chamber environment, the product shipping route, power consumption, and the desired product warranty life are represented by block 10. A user enters these parameters via a program interface, described in greater detail below. The input information is then supplied to subroutines represented by blocks that incorporate consumer behavior 14, application workload information 16 and probable environmental conditions 18, respectively.

Consumer behavior 14, application workload 16, and environmental condition 18 subroutines apply information obtained from attached databases to the information provided in the user inputs 10 to compute estimates of specific parameters related to use conditions of the package/chip such as, for example, the amount of time a particular package/chip-bearing-product is on, the power consumption of the chip, and whether or not the product is generally in a air-conditioned environment. Consumer behavior subroutine 14 applies data compiled from such internal market research and customer surveys that define the likelihood of occurrence for different temperature events. The application workload subroutine 16 applies data from benchmark and field tests that span numerous applications and operating system combinations. Information gathered from these studies includes power consumption associated with a given operational state (e.g., application use, idle, off/sleep). Environmental conditions subroutine 18 derives ambient temperature conditions for the particular product type specified in the user input. The data corresponds to ambient temperatures inside a computer system derived from a function based on atmospheric data and field-tests of different chassis/box combinations.

The combination of user input information 10 and the parameters derived from customer behavior subroutine 14 are supplied to a temperature frequency calculation subroutine represented by block 20. This subroutine derives an estimate of the number of temperature fluctuations that the product undergoes over its lifetime. In particular, the temperature frequency block 20 estimates the number of occurrences in each of several temperature regimes: shipping (air and ground), storage, power on/off, power on to idle, shifts between application use, and shifts within application use, and in some cases temperature changes due to transport by the end user.

The output temperature frequency parameters calculated by the temperature frequency block 20 and the parameters calculated by the application workload 16 and environmental conditions 18 blocks are input to a temperature profile subroutine represented by block 25 which calculates a probability density function for each temperature regime. The distribution of temperatures occurring during the temperature fluctuations, the transition periods during and between fluctuations, ramp times and the amount of time the products dwell at a particular elevated or reduced temperature are also estimated. The temperature profile data output from the temperature profile block is entered directly into a Monte Carlo simulation subroutine to derive a probability density function for estimating the product's temperature over time. This output is shown as a graph in block 28. The graph illustrates multiple sources of temperature fluctuation through the life of the product from shipping to storage to operational use.

In addition, user inputs 10, and single point estimates of the parameters derived from the temperature frequency block 20 and the temperature profile block 25, are input to an accelerated life model, represented by block 30. The accelerated life model 30 includes equations known in the art such as the Coffin-Manson model, which iteratively derives point estimates of the number of accelerated test cycles required to approximate the temperature profile of the product given the provided user inputs. The point estimates are stored as part of a probability density function. The calculations of the accelerated life model 30 are presented as a graph 35 depicting the percentage of package units that are exposed to the number of accelerated life cycles that have been performed.

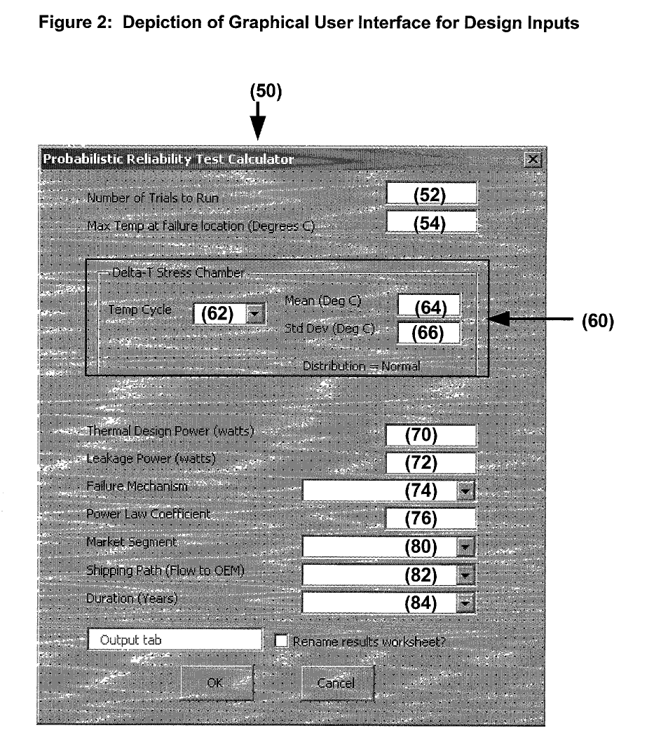

FIG. 2 depicts the program interface 50 used to provide the user inputs 10 to the various subroutines. The program interface 50 may be implemented using any means such as a Visual Basic dialog box, for example. It is noted that the actual design and format of the interface 50 is merely exemplary and that other formats and/or configurations may equally be used. At the top of the program interface is a “Number of Trials to Run” entry box 52, that allows a user to preset the number of Monte Carlo simulations selected for the evaluation. In general, a larger number of simulations (trials) yield higher accuracy associated with the resulting probability density function. The value selected for the number of trials is only restricted to a positive integer. Requirements needed for numerical converge range from as low as 500 to well over 1,000,000 depending on the complexity of the underlying equations. Below the “Number of Trials to Run” box 52, is a “Max Temp at failure location” entry box 54 that enables the user to specify the maximum temperature likely to occur (in degrees Celsius) at the location of the failure mode (described below) for the particular package/chip combination. The maximum temperature value is used as an upper temperature bound and allows the expected temperature distribution during package/chip operation to be scaled appropriately.

Directly below entry boxes 52 and 54, there is a bordered Delta-T stress chamber box 60 including entry boxes 62, 64, 66 via which the parameters describing the accelerated test chamber environment are entered. A Temp Cycle drop down box 62 provides for adjustment of the type of temperature cycle condition within the test chamber, a mean temperature entry box 64 provides for adjustment of the nominal temperature fluctuation (delta) within the chamber (also in degrees Celsius) and a standard deviation box 66 provides for adjustment of the variation about the nominal value assuming a normal distribution of temperature values. The mean temperature delta and standard deviation define the range of values that are input into the accelerated life model 30.

The manner in which an electronic device converts applied electrical power into heat is a particularly significant criterion influencing the package/chip toward a particular failure mode. To account for this criterion, the program interface includes entry boxes for Thermal Design Power (in watts) 70. In addition to basic design specifications such as power consumption, microprocessor architecture is also influential factor. As transistor gate lengths continue to shrink, leakage current is becoming more significant. The Leakage Power 72 estimates the heat generated from this current flow. Further entry items include the Failure Mechanism box 74 that allows the user to select from a predetermined set of failure types such as solder ball fatigue, fretting, cracking, and package/chip interface deformation. The failure mechanism selected is dynamically linked to a value for the power law coefficient shown in box 76. The power law coefficients are values used as the exponents in the Coffin-Manson empirical model used in the Accelerated Life Model (described in greater detail below). The magnitude of the coefficient depends upon the selected failure mode. For instance, historical studies of the power law coefficient for the solder ball fatigue failure mechanism range from approximately 1.9 to 2.1. The Power Law Coefficient input box 76 allows the user to make adjustments to the preset coefficients determined according to the selected failure mode. Such adjustments may be necessary to account for modifications to the chip/package design, for example.

The program interface 50 also allows the user to select the market segment, the shipping path, and the warranty lifetime. Using the Market Segment box 80, the user can choose between CPU and non-CPU market types, such as Desktop, Laptop, Server, Workstation, Telecommunications, Handheld devices, Personal Digital Assistants (PDA) and cellular, among others. The market segment determines the product environment of the package/chip and the consumer use patterns associated with the product. For example, since laptops typically contain a smaller fan, they are subject to higher temperatures than desktops for equal application use. Furthermore, servers are generally kept on constantly except during maintenance and therefore do not undergo as many on/off cycles as the other product types. These differences have a direct effect upon the number and magnitude of the ΔT fluctuations.

Through the Shipping Path entry box 82, the user selects the shipping route that determines the environment that the package/chip will experience en route from the chip manufacturer to a product assembly site to a reseller. These shipping routes offer options ranging from typical flows through a distributor channel to more specialized extended flow routes. Based on tabulated field data, the expected number of freeze/thaw cycles is dynamically linked to each of these shipping routes, and thereby impacts the temperature profile requirements of the package/chip. The Field Life Requirement (shown in FIG. 2 as Duration (years)) box 84 allows the user to specify the length of time that the package/chip is to be evaluated. Generally, the length of time is chosen as the warranty life of the package/chip, which may be one to ten years, for example.

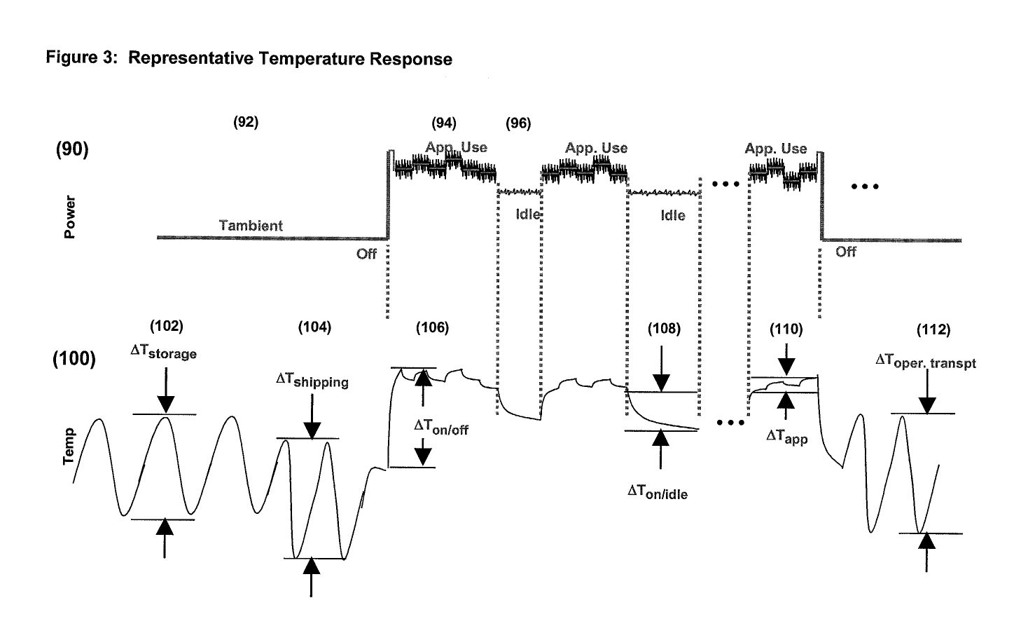

All of the parameters chosen by the user via the program interface 50 are used to model the temperature profile of the package/chip during its lifetime. FIG. 3 schematically illustrates the temperature and power use of an exemplary package/chip used in a particular market segment over time in respective graphs 90 and 100. As can be discerned, the temperature of the package/chip fluctuates widely over time. The range of the temperature fluctuations (denoted as ΔT) depends on the use conditions of the package/chip device. At the beginning of the device lifetime the chip is not running (is off) as shown in portion 92 of the power graph 90, and it is in a storage condition. While in storage, the device experiences ambient temperature fluctuations in accordance with the environmental conditions of the storage locations. The typical temperature fluctuations during storage, denoted ΔT_{storage}, are shown at 102 on the temperature graph 100. At this stage, the number of cycle corresponding to a temperature fluctuation cycles of breadth ΔT_{storge} is estimated for the lifetime of the device. This quantity is computed using the customer data subroutine as indicated above.

After the device is in storage as depicted in temperature graph 100, it is shipped to the Original Equipment Manufacturer (OEM) and eventually the retailer and is subject to temperature fluctuations during the shipping process of magnitude ΔT_{shipping} 104. The ΔT_{shipping} fluctuations can be subdivided into ground and air shipping cycles, each having its own particular ambient temperature conditions. The approximated number of ground and air shipping cycles for ΔT_{shipping} is also determined through field studies and the Environmental Conditions algorithm 18. It is noted in this context that the temperature graph is merely an exemplary and schematic representation of the actual sequence of temperature fluctuations. For instance, the storage and shipping events may occur in different combinations and sequences.

After the shipping cycles end as shown in the power and temperature graphs 90 and 100, the device is installed and put into operation. When the device is turned on, power use increases from zero in the off state 92 to a power level associated with typical application use 94. As the chip consumes power, the temperature of the package/chip device rapidly increases from a baseline in the off state to a local maximum. For high power electronic devices, the rate of temperature change during these power cycles is distinctly different from the rates of temperature change during other fluctuation cycles (e.g., storage and shipping) that occur due to changes in the ambient temperature in the environment of the package/chip device. The rapid conversion of electrical power to heat in this process also causes thermal gradients to form in across the components of the package/chip device. As a result of these gradients, environmental test methods for warranty reliability testing must be conducted differently. The on/off power cycle fluctuation at the chip die is shown as ΔT_{on/off} 106. Once a steady state temperature is reached, temperature fluctuations still occur that are driven by changes in power within and between software use. The resulting fluctuations are characterized by a maximum fluctuation amplitude ΔTₐₚₚ 110.

After the chip runs an application for some time, it may enter an idle state in which a much smaller amount of power is consumed but no application is running. In the idle state the chip performs no operations and thus consumes less power, causing the temperature of the device to decrease to an idle-state baseline determined by the design characteristics of the chip (e.g. Leakage Power). The temperature fluctuations between operational and idle states have a typical magnitude ΔT_{on/idle} 108. In addition, as different applications are used or executed, the power use fluctuates (as shown at 96).

The temperature fluctuations ΔT_{on/off} and ΔT_{on/idle} are derived from the user inputs about primarily chip design characteristics and to a lesser extent the market segment and the consumer behavior subroutines. The application use fluctuations ΔTₐₚₚ are calculated with the additional aid of the application use subroutine that stores information concerning the power consumed by various applications. The number of such events is calculated using user inputs and the relevant consumer behavior and application use subroutines. If the market segment selected in the user inputs is a mobile segment such as Laptops, the package/chip device is also exposed to further ambient temperature fluctuation cycles caused by movement of the mobile device between locations. These fluctuations are denoted by ΔT_{userxfer} 112.

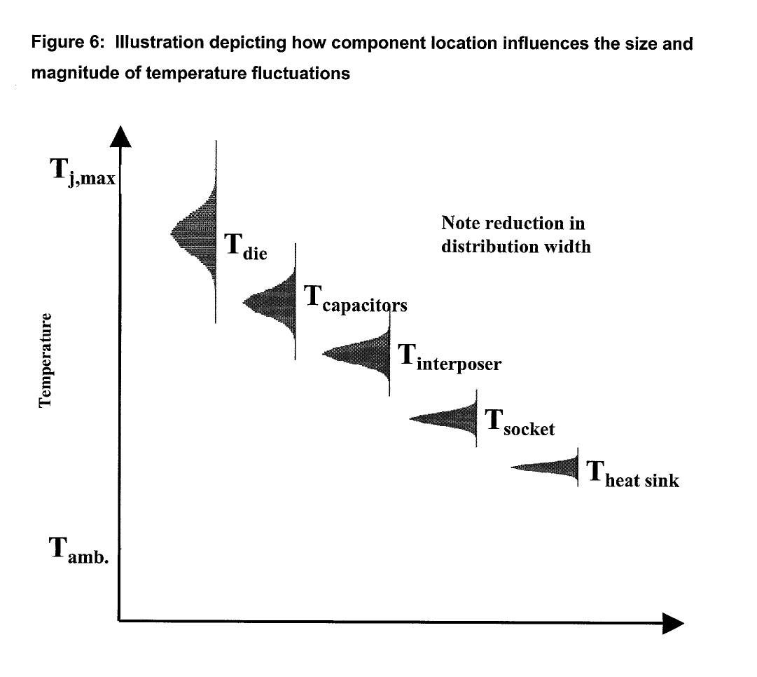

Each of the temperature fluctuations ΔT, pertaining to any of the ambient temperature cycles or power cycles discussed above is not modeled as a constant, but rather can be mathematically modeled as a distribution with corresponding parameters (e.g. mean and standard deviation in the case of a normal distribution). In addition, location affects are accounted for in the application workload 16 algorithm. For example, failure modes that occur farther from the die such as the capacitors, interposers, socket and heat sink, will have smaller temperature drops to ambient temperatures and will vary less, as depicted by narrower temperature distributions as shown schematically in FIG. 6.

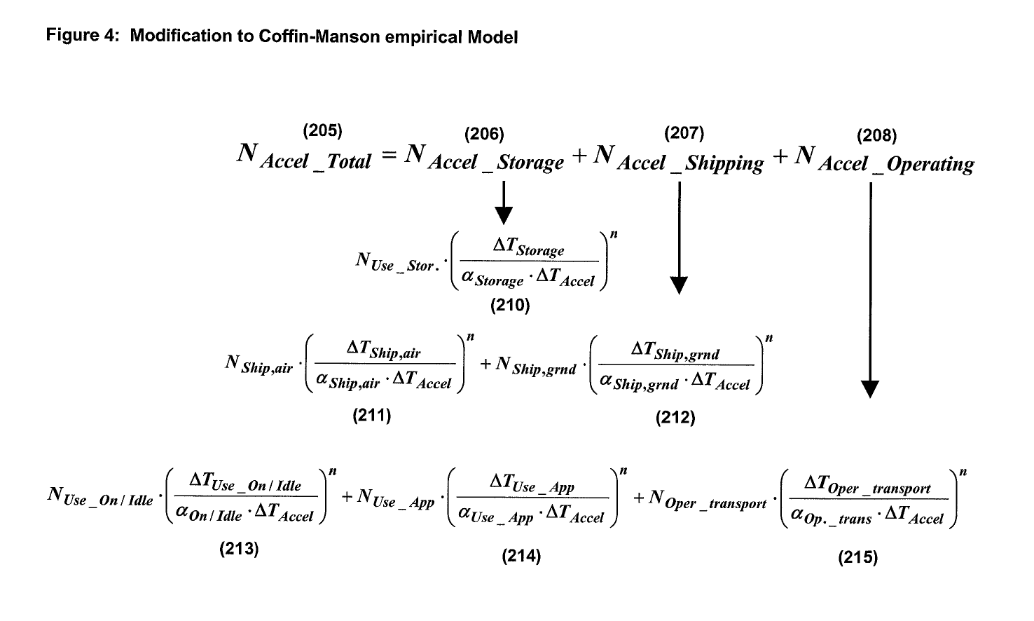

When the magnitude and frequency of the temperature fluctuation (non-on/off power cycle) events have been fully accounted for and estimated, these values are input into an accelerated life model such as the Modified Coffin-Manson empirical model depicted in FIG. 4. According to this modified model, the total number of accelerated reliability cycles required to accurately model the temperature profile of the package/chip device is equivalent to a sum of:

1) the number of accelerated test cycles required to separately model temperature fluctuations due to storage cycles;

2) the number of accelerated test cycles required to separately model temperature fluctuations due to shipping cycles, both ground and air;

3) the number of accelerated test cycles required to separately model power cycle fluctuations including on/idle, application use, and, if the market segment is of a mobile type, cycles due to movement of the product between various locations and/or environments.

Equation 205 in FIG. 4 shows this equation, with summation terms 206, 207 and 208. In turn, each of the terms 206, 207, 208 is related to the estimated number of storage, shipping and operation cycles occurring over the device lifetime (shown in FIG. 3) according to the equivalence arrows shown in FIG. 4. As indicated in FIG. 4, the number of accelerated test cycles required to model a type of fluctuation event is equivalent to the estimated number of actual fluctuation cycles that will take place in the device's lifetime multiplied by temperature fluctuation ratios raised to the power coefficient (n) specified through the program interface (related to the failure mode). These multiplication-product terms are referred to as usage cycle terms 210, 211, 212, 213, 214, 215.

Each of the temperature fluctuation ratios of the usage cycle terms are equal to an expected temperature change for the particular use divided by the temperature fluctuations within the acceleration chamber multiplied by a offset multiplier, α. The α term accounts for differences in creep and plasticity effects resulting under use condition temperatures as compared to those incurred under the accelerated test conditions.

The a term is uniquely defined for each temperature fluctuation regime, since the mean temperature varies between use types (regimes). Therefore, through ΔTᵤₛₑ and α, each of the six usage cycle terms 210, 211, 212, 213, 214, 215 (storage, shipping air, shipping ground, application use, on/idle, and operating transport) has a corresponding temperature fluctuation ratio.

Since the ΔT values for each of the different fluctuation types are defined by probability density functions rather than exact values, each of the usage cycle terms (being functions of the ΔT values) range in values according to a corresponding probability density function. Moreover, since the total number of acceleration cycles N_{accel}_{_{—}}ₜₒₜₐₗ is equal to the summation of the six usage terms, it also is described by a probability density function. These estimated number of acceleration test cycles, N_{accel}_{_{—}}ₜₒₜₐₗ, needed to test the reliability of the package/chip vary over a range of values from a minimum of N₁ cycles to a maximum of approximately N₂ cycles. As a consequence, if fewer than N₁ cycles are performed, the acceleration test provides a 0% certainty level, while if greater than N₂ cycles are performed, the certainty level approaches 100% of the population. Accordingly, the area in between N₁ and N₂ corresponds to the certainty level of the accelerated test. This certainty level ranges between 0 and 100 percent and allows the user to specify a specific numbers of acceleration cycles corresponding to a certainty level of interest.

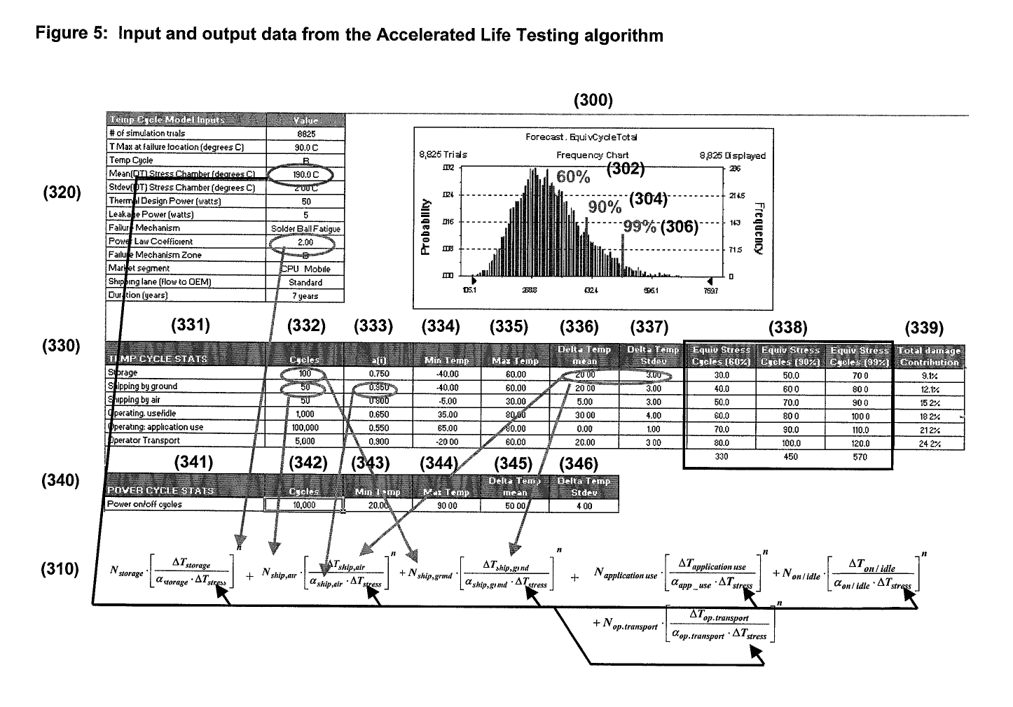

FIG. 5 displays exemplary input and output data from a calculated temperature profile and accelerated life model for a Mobile computer that incorporates a package/chip device. The output includes a graph of the probability density function of N_{accel}_{_{—}}ₜₒₜₐₗ 300 and a tabulation of calculated parameters including estimates of the number of and magnitude of temperature fluctuations in each of the six temperature regimes. As can be discerned, the circles and arrows in the tables indicate how listed parameters are used in the usage terms 310 of the modified Coffin-Manson model equation shown at the bottom of the figure. In FIG. 5, there are three tables of values as shown: the first table 320 lists the user inputs entered via the program interface; a second table 330 summarizes the Temperature Cycle test requirements, and a third table 340 summarizes the Power Cycle test requirements. Table 330 contains several summary statistics for each temperature fluctuation regime 331 which includes the approximated number of fluctuation cycles 332, the creep and plasticity adjustment term 333, the minimum 334 and maximum 335 temperatures, the mean temperature fluctuation 336, the standard deviation of the temperature fluctuation 337, the number of equivalent acceleration test cycles corresponding to the 60%, 90%, and 99% certainty levels 338, and finally the damage (expressed as a percentage of total damage) associated with a particular regime of the package/chip 339. Similarly, Table 340 provides the summary statistics for the number of cycles 341, minimum 342 and maximum 343 temperatures, the mean temperature fluctuation 344, and its corresponding standard deviation 345. It is again noted that the format and values of the tabulated results shown in FIG. 5 are merely exemplary.

As shown in FIG. 5, two of the factors in the user input area 320, the mean temperature fluctuation in the testing chamber, and the power law coefficient, are circled. An arrow points from mean temperature fluctuation value (equal to 190° C. in the example shown) to each of the ΔT_{accel} values in the usage terms 310, and another arrow points from the power law coefficient value (equal to 2.0 in the example shown) to the exponent (n) in the shipping usage term (although all usage terms have the same exponent (n)). Similarly, each of the approximated number of fluctuation cycles 332 and the mean temperature fluctuation 336 and 337 for each of the six temperature fluctuation regimes 331 are circled and have arrows pointing to where each of these values are used in the usage term corresponding to the temperature regime. In this way, FIG. 5 clearly indicates the derivation of the N_{accel}_{_{—}}ₜₒₜₐₗ probability density function shown in graph 300.

The results of the probability density function are summarized in section 338 for the 60%, 90%, and 99% levels. These values are merely exemplary as any level of certainty may be specified. The certainty levels can be interpreted as the percentage of package/chip devices that experience at least that level of stress over its warranty life. The precision of these estimates is a function of the number of Monte Carlo simulation trials. As described above, the greater the number of accelerated test cycles that the device is exposed to without failure, the greater the level of certainty that the device will be able to withstand temperature fluctuations in the field. For this reason, the 99% certainty level corresponds to 570 cycles, which is greater than the number of cycles for the 90% (450 cycles), and the 60% levels (330 cycles). The 60%, 90% and 99% certainty levels are shown by respective dash marks 302, 304 and 306.

The output shown in FIG. 5 provides an approximation of the expected value (mean) and variability (standard deviation) of the various temperature cycles. As a result of the uncertainty or lack of precision associated with previous methods known in the art, the range (standard deviation) of ΔT estimates are often several multiples greater than those calculated in the output. This suggests that current methods carry inflated estimates of variability that are far too conservative and can be reduced significantly. It is therefore clear that quantifying the contributions of each of the temperature regimes separately dramatically affects the guard bands used in the accelerated life model.

In the foregoing description, the method of the invention has been described with reference to a number of examples that are not to be considered limiting. Rather, it is to be understood and expected that variations in the principles of the method herein disclosed may be made by one skilled in the art, and it is intended that such modifications, changes, and/or substitutions are to be included within the scope of the present invention as set forth in the appended claims. In addition, the principles of the method of the invention may be applied to alternate Accelerated Life Models such as an Arrhenius relationship for sustained high temperature exposure. In addition, this approach may be applicable to areas outside package/chip reliability testing. For example, the foregoing method may also be applicable to silicon-based defect modeling.

Furthermore, while the mechanisms described can be embodied in hardware within a computer processor, the invention is not necessarily limited thereby, and the programmed logic that implements the mechanisms can be separately embodied and stored on a storage medium, such as read-only-memory (ROM) readable by a general or special purpose programmable computer, for configuring the computer when the storage medium is read by the computer to perform the functions described above.

What is claimed is:

1. A method of quantifying the reliability test requirements of a package/chip device over a product lifetime comprising:
modeling different types of ambient and power-driven temperature cycle fluctuations the package/device is expected to undergo over the product lifetime; and
determining the accelerated life test requirements that represent each of the different types of temperature cycles fluctuations.

2. The method of claim 1, wherein the different types of ambient and power-driven temperature cycles are: storage cycles, air shipping cycles, ground shipping cycles, on/idle operation cycles, power on/off, application use cycles within and between program use, and product transfer cycles.

3. The method of claim 1, wherein the test requirements depend upon a market application use of the package/chip device.

4. A method of relating accelerated life test parameters used to assess reliability of a package/chip device to expected frequencies and magnitudes of temperature cycle fluctuations encountered by the package/chip device over a product lifetime, the method comprising:
defining a particular market application use for the package/chip device;
quantifying expected frequencies and magnitudes of temperature fluctuations of the package/chip device in each of a plurality of temperature cycle fluctuation regimes, based in part on the particular market application use of the package/chip device; and
incorporating the quantified expected frequencies and magnitudes of the temperature fluctuations of the package/chip device in each of the temperature regimes into an accelerated life model.

5. The method of claim 4, wherein the ambient and power-driven temperature cycle fluctuation regimes include at least one of:
storage cycles;
air shipping cycles;
ground shipping cycles;
on/idle cycles;
within and between application use cycles;
operator transport cycles;
power on/off cycles

6. The method of claim 5, further comprising:
providing a program interface for receiving user inputs regarding package/chip device design, use, and environmental test chamber parameters;
including the user inputs and a warranty life associated with the market application use; and
using subroutines to calculate parameters related to use conditions of the package/chip device in the market application by retrieving field data from databases.

7. The method of claim 6, wherein the subroutines include at least:
a consumer behavior subroutine that applies information relating to typical consumer behavior associated with the market application specified;
an application workload subroutine that applies information relating to power consumption of various typical applications; and
an environmental conditions subroutine that applies information relating to both external and internal temperature conditions associated with the market application specified.

8. The method of claim 6, further comprising:
estimating ambient temperature fluctuation frequencies for each of the temperature cycle fluctuation regimes over the lifetime of the product based on the user inputs and the parameters calculated by the subroutines; and
estimating power driven temperature fluctuation frequencies over the lifetime of the product based on the user inputs and the parameters calculated by the subroutines.

9. The method of claim 8, further comprising:
calculating a temperature profile of the package/chip device over the lifetime of the product using the estimated ambient temperature fluctuation frequencies, the estimated power driven fluctuation frequencies, and the parameters calculated by the subroutines;
wherein the temperature profile includes a probability density function for each temperature fluctuation regime and the power cycle fluctuations.

10. The method of claim 9, wherein the temperature profiles also include an estimate of rates of temperature change, ramp times and dwell times in each ambient temperature cycle fluctuation regime and in the power driven temperature cycle fluctuations.

11. The method of claim 9, further comprising:
inputting the user inputs, temperature fluctuation frequencies, and temperature profile into the accelerated life model;
calculating, according to the accelerated life model, a probability density function of a number of accelerated test cycles required to simulate the temperature fluctuations that occur over the product lifetime; and
calculating a number of accelerated on/off power cycles required to simulate the on/off power cycle fluctuations that occur over the product lifetime;
wherein the calculations are based on the input user inputs, temperature fluctuation frequencies, power cycle fluctuation frequencies and temperature profile; and the user inputs which include a power law coefficient and a failure mode type.

12. The method of claim 11, further comprising:
outputting the temperature profile and the probability density function of the number of accelerated test cycles required to simulate the ambient temperature fluctuations in tabular and graphic form; and
outputting the probability density function of the number of accelerated on/off power cycles required to simulate the on/off power cycle fluctuations in tabular and graphic form;
wherein the probability density functions of the number of accelerated test cycles and the number of on/off power cycles required to simulate the temperature fluctuations and on/off power cycle fluctuations indicates respective numbers of accelerated test cycles and accelerated on/off power cycles required to achieve various confidence levels that the package/chip device will not fail over the warranty lifetime.

13. The method of claim 11, wherein the accelerated life model includes a modified Coffin-Manson empirical model.

14. The method of claim 12, wherein the modified Coffin-Manson model calculates a total number of required accelerated test cycles as a sum of usage terms quantifying the stresses contributed by each ambient and power driven temperature cycle fluctuation regime, the usage terms being equal to the number of temperature fluctuation cycles occurring in each regime multiplied by a temperature fluctuation ratio raised to the power of the power law coefficient.

15. The method of claim 14, wherein the temperature fluctuation ratio includes a material property factor to account for temperature creep and plasticity.

16. A method of systematically quantifying representative field use conditions associated with a particular product having a package/chip device, the method comprising:
defining a product market segment;
defining a shipping route taken by the product;
identifying temperature cycle fluctuations and power cycles fluctuations encountered by the package/chip of the product; and
quantifying frequencies and magnitudes of temperature fluctuations pertinent to each identified ambient and power driven temperature fluctuation, wherein the frequencies and magnitudes are based in part on the product market segment and the shipping route.

17. The method of claim 16, further comprising:
extracting information from databases related to customer behavior, application workload, and environmental conditions applicable to the product market segment and shipping route of the product; and
determining frequencies and magnitudes of ambient and power driven temperature fluctuations for the life of the product based on the extracted information.

18. The method of claim 17, further comprising:
defining a warranty life of the product; and
calculating a temperature profile for the package/chip device over the warranty life of the product based on the quantified frequencies and magnitudes of each ambient and power driven temperature fluctuation.

19. An article comprising a computer-readable storage medium which stores computer-executable instructions for causing a computer system to:
define a particular market application use for the package/chip device;
quantify expected frequencies and magnitudes of temperature fluctuations of the package/chip device in each of a plurality of temperature cycle fluctuation regimes, based in part on the particular market application use of the package/chip device; and
incorporate the quantified expected frequencies and magnitudes of the temperature fluctuations of the package/chip device in each of the temperature regimes into an accelerated life model.

20. The article of claim 19, wherein the storage medium stores further instructions for causing a computer system to:
provide a program interface for receiving user inputs regarding package/chip device design, use, and environmental test chamber parameters;
include user inputs and a warranty life associated with market application use; and
process the user inputs in subroutines, the subroutines calculating parameters related to use conditions of the package/chip device in the market application use by retrieving field data from databases.

21. The article of claim 20, wherein temperature fluctuation regimes include at least one of:
(a) storage cycles;
(b) air shipping cycles;
(c) ground shipping cycles;
(d) on/idle cycles;
(e) varied application use cycles;
(f) operator transport cycles; and
(g) power on/off cycles.

22. The article of claim 20, wherein the storage medium stores further instructions for causing a computer system to:
estimate temperature fluctuation frequencies for each of the temperature cycle fluctuation regimes over the warranty life of the product based on the user inputs and the parameters by the subroutines; and
calculate a temperature profile of the package/chip device over the warranty life of the product using the estimated temperature fluctuation frequencies and the parameters calculated by the subroutines.
